(19) United States
(12) Patent Application Publication
(10) Pub. No.: US 2019/0047702 A1
(43) Pub. Date: Feb. 14, 2019

(54) AERIAL VEHICLE

(71) Applicant: CAINIAO SMART LOGISTICS HOLDING LIMITED, Grand Cayman (KY)

(72) Inventors: SHAOHUA CHEN, HANGZHOU (CN); ANZHAI PENG, HANGZHOU (CN); YANG GAO, HANGZHOU (CN); YONG WANG, HANGZHOU (CN); WENZHE LI, HANGZHOU (CN); KEYU WU, HANGZHOU (CN)

(21) Appl. No.: 16/059,786

(22) Filed: Aug. 9, 2018

(30) Foreign Application Priority Data
Aug. 11, 2017 (CN) 201710685532.7

(51) Int. Cl. B64C 39/02; B64D 27/24; B64D 17/78; B64D 45/00; B64D 31/06

(52) U.S. Cl. CPC B64C 39/024; B64D 27/24; B64D 17/78; B64D 45/00; B64D 31/06; B64D 2045/0085; B64C 2201/146; B64D 2201/00; B64D 2221/00; B64C 2201/024; B64C 2201/042; B64C 2201/141; B64D 2045/008

(57) ABSTRACT

An aerial vehicle comprises: an electric power supply device, a motive power device, and a protective device disposed in an aerial vehicle body. The electric power supply device is configured to supply electric power to the motive power device or the protective device. The protective device is configured to reduce an exerted force between the aerial vehicle and another object when the aerial vehicle collides with the another object.

### CROSS REFERENCE TO RELATED APPLICATION

The present application is based on and claims priority to Chinese Patent Application No. 201710685532.7, filed on Aug. 11, 2017, which is incorporated herein by reference in its entirety.

### TECHNICAL FIELD

The present application relates to the field of flight technology, and in particular, to an aerial vehicle.

### BACKGROUND

An aerial vehicle is often actuated by a radio remote control and its own control device, and can be applied to various fields such as aerial photography, electric power routing inspection, mapping, and express delivery transportation. As the aerial vehicle application field becomes wider, potential dangers also gradually surface. Especially since an aerial vehicle often operates outdoors, it is prone to interference by environmental factors, resulting in an abnormal flight or even a crash.

Existing aerial vehicles lack hazard prevention equipment, and will be easily damaged or cause damage to ground objects after crashing.

### SUMMARY

In view of this, the present disclosure provides an aerial vehicle that can protect itself and ground objects when falling. To realize the objective, the technical solutions of the present disclosure are provided as follows.

An aerial vehicle includes an electric power supply device, a motive power device, and a protective device disposed in an aerial vehicle body. The electric power supply device is configured to supply electric power to the motive power device or the protective device. The protective device is configured to reduce an exerted force between the aerial vehicle and another object when the aerial vehicle contacts the another object.

In an implementation manner, the protective device includes a parachute disposed on a top surface of the aerial vehicle body and/or a safety airbag disposed on a bottom surface of the aerial vehicle body. In an implementation manner, the protective device further includes an altitude sensor. The altitude sensor is connected to the safety airbag and is configured to open the safety airbag when detecting an altitude of the aerial vehicle body satisfies a preset condition.

In an implementation manner, the aerial vehicle further includes a switch. One end of the switch is connected to the electric power supply device, and the other end is connected to the motive power device or the protective device.

In an implementation manner, the aerial vehicle further includes a remote controller. The remote controller is configured to send a switching instruction to the switch, the instruction is configured to break a connection between the other end of the switch and the motive power device and establish a connection between the other end of the switch and the protective device.

In an implementation manner, the aerial vehicle further includes a first processor and a flight data collector. The flight data collector is configured to collect flight data of the aerial vehicle and send the flight data to the first processor. The first processor is configured to determine whether the aerial vehicle is in an abnormal flight status according to the flight data, and if the aerial vehicle is in the abnormal flight status, send a switching instruction to the switch, the instruction is configured to break a connection between the other end of the switch and the motive power device and establish a connection between the other end of the switch and the protective device.

In an implementation manner, the aerial vehicle further includes a second processor. The second processor is configured to send a first instruction to the motive power device, the first instruction being configured to instruct the motive power device to stop providing a driving force to the aerial vehicle, and send a second instruction to the protective device, the second instruction being configured to initiate the protective device.

In an implementation manner, the motive power device further includes an electronic speed regulator. The electronic speed regulator is connected to the second processor and is configured to set a voltage output to an electric motor of the motive power device to a preset minimum value after receiving the first instruction.

In an implementation manner, the second instruction is configured to establish a connection between the protective device and the electric power supply device.

In an implementation manner, the aerial vehicle further includes a first switch and a second switch. The first switch is connected to the electric power supply device and the motive power device respectively, and the second switch is connected to the electric power supply device and the protective device respectively.

According to one aspect, an aerial vehicle comprises: an electric power supply device, a motive power device, and a protective device disposed in an aerial vehicle body. The electric power supply device is configured to supply electric power to the motive power device or the protective device. The protective device is configured to reduce an exerted force between the aerial vehicle and another object when the aerial vehicle collides with the another object.

In some embodiments, the protective device comprises a parachute disposed on a top surface of the aerial vehicle body. In some embodiments, the protective device comprises a safety airbag disposed on a bottom surface of the aerial vehicle body. The protective device further comprises an altitude sensor; and the altitude sensor is connected to the safety airbag and is configured to open the safety airbag when detecting an altitude of the aerial vehicle body satisfies a preset condition.

In some embodiments, the aerial vehicle further comprises a switch. One end of the switch is connected to the electric power supply device, and the other end is connected to the motive power device or the protective device. The switch is configured to obtain from a remote controller a switching instruction to cause the switch to break a connection between the other end of the switch and the motive power device and establish a connection between the other end of the switch and the protective device. The aerial vehicle may further comprise a first processor and a flight data collector. The flight data collector is configured to collect flight data of the aerial vehicle and send the flight data to the first processor. The first processor is configured to determine whether the aerial vehicle is in an abnormal flight status according to the flight data, and if the aerial vehicle is in an abnormal flight status, send a switching instruction to the switch, to cause the switch to break a connection between the other end of the switch and the motive power device and establish a connection between the other end of the switch and the protective device.

In some embodiments, the aerial vehicle further comprises a second processor configured to send a first instruction to the motive power device, to cause the motive power device to stop providing a driving force to the aerial vehicle, and send a second instruction to the protective device to cause the protective device to initiate. The motive power device further comprises an electronic speed regulator. The electronic speed regulator is connected to the second processor and is configured to set a voltage output to an electric motor of the motive power device to a preset minimum value after receiving the first instruction.

In some embodiments, the aerial vehicle further comprises a first switch and a second switch. The first switch is connected to the electric power supply device and the motive power device respectively on two ends of the first switch, and the second switch is connected to the electric power supply device and the protective device respectively on two ends of the second switch.

According to another aspect, an aerial vehicle comprises: an electric power supply device, a motive power device, a switch, and a protective device. A first end of the switch is connected to the electric power supply device, and a second end of the switch is controlled to connect to either the motive power device or the protective device. The electric power supply device is configured to supply electric power to the motive power device or the protective device corresponding to the connection of the second end. After the second end is connected to the protective device, the protective device is configured to reduce an exerted force between the aerial vehicle and another object when the aerial vehicle collides with the another object. The protective device comprises a parachute and a safety airbag.

In some embodiments, the parachute is disposed on a top surface of a body of the aerial vehicle; and the safety airbag is disposed on a bottom surface of a body of the aerial vehicle.

In some embodiments, the protective device further comprises an altitude sensor; and the altitude sensor is connected to the safety airbag and is configured to open the safety airbag when detecting an altitude of the aerial vehicle satisfies a preset condition.

In some embodiments, the switch is configured to obtain from a remote controller a switching instruction to cause the switch to break a connection between the second end of the switch and the motive power device and establish a connection between the second end of the switch and the protective device.

In some embodiments, the aerial vehicle further comprises a first processor and a flight data collector. The flight data collector is configured to collect flight data of the aerial vehicle and send the flight data to the first processor; and the first processor is configured to determine whether the aerial vehicle is in an abnormal flight status according to the flight data, and if the aerial vehicle is in an abnormal flight status, send a switching instruction to the switch, to cause the switch to break a connection between the second end of the switch and the motive power device and establish a connection between the second end of the switch and the protective device.

In some embodiments, the aerial vehicle further comprises a second processor. The second processor is configured to send a first instruction to the motive power device, to cause the motive power device to stop providing a driving force to the aerial vehicle, and send a second instruction to the protective device to cause the protective device to initiate.

According to another aspect, a method is implementable by an aerial vehicle including an electric power supply device, a motive power device, a switch, a protective device, a first processor, and a flight data collector. The method may comprise: connecting a first end of the switch to the electric power supply device and a second end of the switch to the motive power device for the electric power supply device to supply electric power to the motive power device; collecting, by the flight data collector, flight data of the aerial vehicle and send the flight data to the first processor; determining, by the first processor, whether the aerial vehicle is in an abnormal flight status according to the flight data, and if the aerial vehicle is in an abnormal flight status, sending, by the first processor, a switching instruction to the switch, to cause the switch to break the connection between the second end of the switch and the motive power device and establish a connection between the second end of the switch and the protective device, the protective device comprising a parachute and a safety airbag; and after the second end is connected to the protective device, launching the parachute and the safety airbag to reduce an exerted force between the aerial vehicle and another object when the aerial vehicle collides with the another object.

In some embodiments, the parachute is disposed on a top surface of a body of the aerial vehicle, and the safety airbag is disposed on a bottom surface of a body of the aerial vehicle.

In some embodiments, the protective device further comprises an altitude sensor, and the abnormal flight status includes that an altitude of the aerial vehicle body satisfies a preset condition.

According to the foregoing technical solutions, an electric power supply device, a motive power device, and a protective device may be disposed in an aerial vehicle body. The electric power supply device is configured to supply electric power to the motive power device or the protective device, the protective device can implement its function when the electric power supply device supplies electric power, that is, reducing an exerted force between the aerial vehicle and another object when the aerial vehicle contacts the another object, for example, colliding with the another object in a landing process. The protective device has the function of preventing the aerial vehicle from being damaged or damaging other objects, so as to protect the aerial vehicle and other objects.

### BRIEF DESCRIPTION OF THE DRAWINGS

To describe the technical solutions of the embodiments of the present disclosure or the existing technology more clearly, the following briefly introduces the accompanying drawings required for describing the embodiments or the existing technology. Apparently, the accompanying drawings in the following description show only some embodiments of the present disclosure, and a person of ordinary skill in the art can still derive other drawings from these accompanying drawings without creative efforts.

FIG. 1 shows a schematic structural diagram of an aerial vehicle according to some embodiments of the present disclosure.

FIG. 2 shows another schematic structural diagram of an aerial vehicle according to some embodiments of the present disclosure.

FIG. 3A shows a schematic structural diagram of arrangement of the parachute and the safety airbag in the aerial vehicle according to some embodiments of the present disclosure.

FIG. 3B shows a schematic diagram of an effect of using the parachute and the safety airbag of the aerial vehicle according to some embodiments of the present disclosure.

FIG. 4 shows another schematic structural diagram of an aerial vehicle according to some embodiments of the present disclosure.

FIG. 5 shows another schematic structural diagram of an aerial vehicle according to some embodiments of the present disclosure.

FIG. 6 shows a flow chart of an aerial vehicle operation method according to some embodiments of the present disclosure.

### DETAILED DESCRIPTION

The following clearly and completely describes the technical solutions in the embodiments of the present disclosure with reference to the accompanying drawings. Apparently, the described embodiments are some rather than all of the embodiments. All other embodiments obtained by a person of ordinary skill in the art based on the embodiments of the present disclosure without creative efforts shall fall within the protection scope of the present disclosure.

During aerial vehicle operation, the aerial vehicle may experience having an unsteady flying pose, or crash in severe cases. If the aerial vehicle lacks a safety protection device, aerial vehicle parts or ground objects may be damaged. Alternatively, the aerial vehicle does not fall but the flight status of the aerial vehicle is abnormal, so continuing the flight may exacerbate the situation, and at this time, the aerial vehicle needs to be controlled to crash, and at the same time, the safety of the aerial vehicle and other ground objects should be ensured during the falling process.

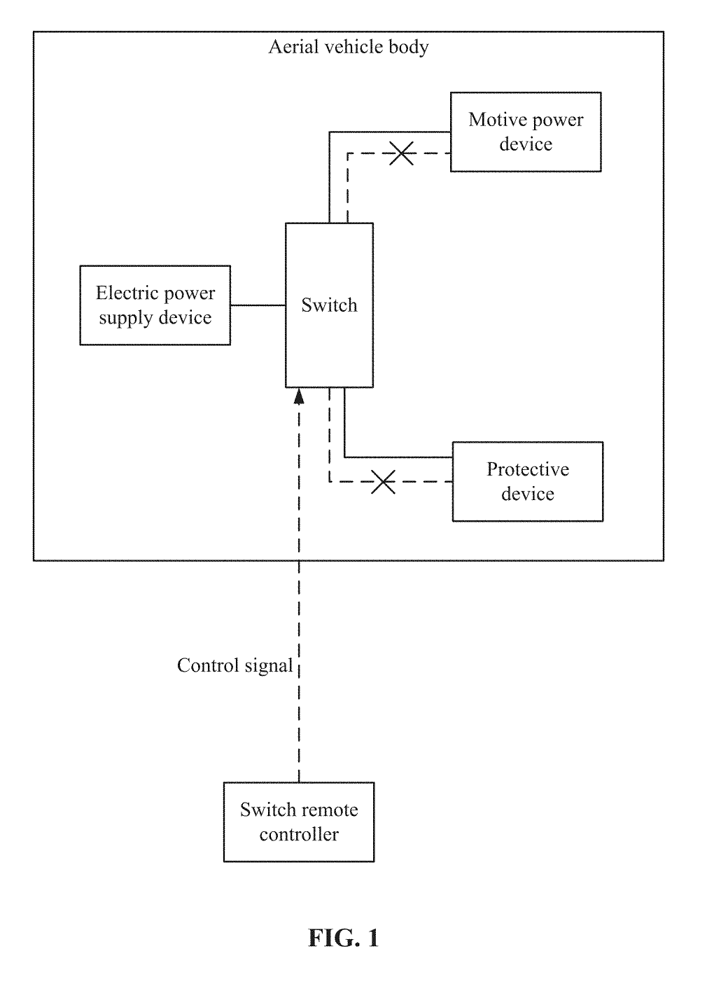

To realize safe landing, the present disclosure provides an aerial vehicle having a safe landing function. The aerial vehicle may comprise a multi-rotor aerial vehicle, a helicopter, a fixed-wing aerial vehicle, a drone, etc. A structure of the aerial vehicle is shown in FIG. 1. With reference to FIG. 1, the aerial vehicle includes an aerial vehicle body and a switch remote controller, and an electric power supply device, a motive power device, a protective device, and a switch are disposed in the aerial vehicle body.

The electric power supply device is an airborne electric power supply, one end (first end) of the switch is connected to the electric power supply device, and the other end (second end) is connected to the motive power device or the protective device. As shown in FIG. 1, a solid line among the switch, the motive power device, and the protective device represents a connected status, and a dotted line with a cross represents a disconnected status. In view of the above, when the switch is connected to the motive power device, the switch is disconnected with the protective device, and when the switch is disconnected with the motive power device, the switch is connected with the protective device. The switch can include, but is not limited to, a relay switch.

In some embodiments, when the switch is connected to the motive power device, the electric power supply device is electrically connected to the motive power device, so as to supply electric power to the motive power device; and when the switch is connected to the protective device, the electric power supply device is electrically connected to the protective device, so as to supply electric power to the protective device.

In some embodiments, when the aerial vehicle is in a normal flight status, the switch is connected to the motive power device, so that the electric power supply device supplies electric power to the motive power device. The motive power device includes motive power parts such as a propeller and wings and an electric motor for providing a driving force to the motive power parts. When the electric power supply device supplies electric power to the motive power device, the electric motor provides a driving force to the motive power parts, so that the motive power parts can operate to enable the aerial vehicle to fly normally.

As shown in FIG. 1, if a ground operator finds that an aerial vehicle is in an abnormal flight status, such as flying unsteadily and falling, the ground operator can control the switch remote controller to send a control signal to the switch in the aerial vehicle body. The control signal can be a radio signal, and can be received by a receiving antenna disposed on the aerial vehicle body and sent to the switch. The switch may obtain from a remote controller a switching instruction to cause the switch to break a connection between the other end of the switch and the motive power device and establish a connection between the other end of the switch and the protective device, for example, when the aerial vehicle is at the abnormal flight status.

The control signal is configured to control the switch to break a connection with the motive power device, and establish a connection with the protective device. When the switch and the protective device are connected, the electric power supply device supplies electric power to the protective device. In some embodiments, after the switch breaks the connection with the motive power device, motive power parts such as the propeller and wings stop working. The motive power parts stop working to not only avoid scratch damages, but also ensure that the aerial vehicle body is only subject to gravity before the protective device is initiated, so that the protective device can function to the greatest extent, and furthermore, prevent the motive power parts from impacting the protective device, for example, prevent the propeller from scrambling and damaging ropes of a parachute and protect the parachute from failing.

In some embodiments, the switch remote controller can also send another control signal, and the control signal is configured to control the switch to break a connection with the protective device, and establish a connection with the motive power device. Thus, the aerial vehicle can be changed into a flight status from the protected status.

The aerial vehicle includes a switch, and the switch is configured to make the electric power supply device to supply electric power to the motive power device or the protective device. However, the device for implementing the function of the electric power supply device is not limited to the switch, and can be another device. For example, the electric power supply device has at least two ways to supply the electric power, and has a control function. The control function is implemented as that, when one line supplies electric power to the motive power device, the other line is controlled not to supply electric power to the protective device; or when one line supplies electric power to the protective device, the other line is controlled not to supply electric power to the motive power device. For example, the other device can be a flight controller described in the subsequent text, and the aerial vehicle achieves the function of the switching through a turning-on instruction and a turning-off instruction. The flight controller will be described in detail below.

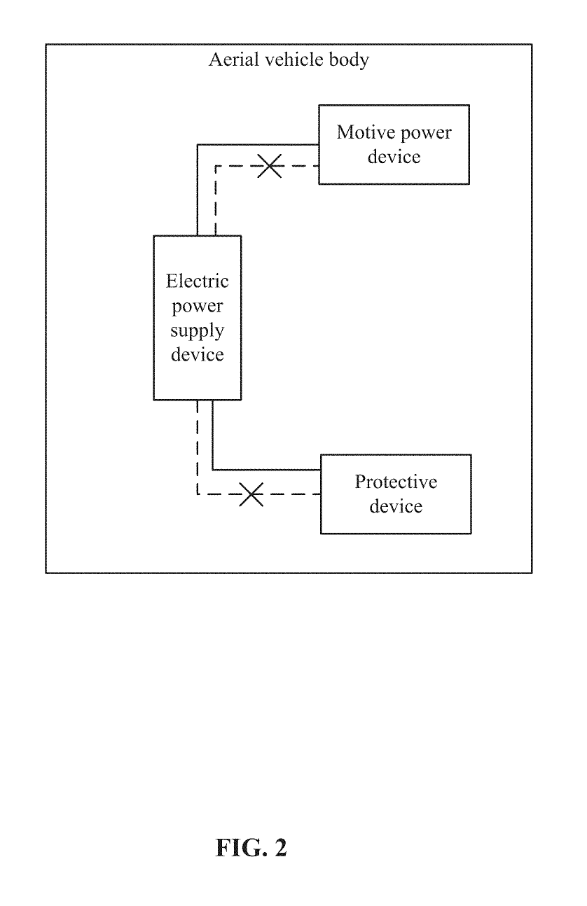

No matter which configuration is used to control electric power supply of the electric power supply device, the electric power supply device can supply electric power to the motive power device or the protective device. On the basis of this, the present disclosure can provide an aerial vehicle, and as shown in FIG. 2, an electric power supply device, a motive power device, and a protective device are disposed in the aerial vehicle body of the aerial vehicle. As shown in FIG. 2, when the electric power supply device and the motive power device are connected through a solid line, it represents that the electric power supply device supplies electric power to the motive power device; when the electric power supply device and the motive power device are connected through a dotted line, it represents that the electric power supply device supplies no electric power for the motive power device; when the electric power supply device and the protective device are connected through a solid line, it represents that the electric power supply device supplies electric power to the protective device; and when the electric power supply device and the protective device are connected through a dotted line, it represents that the electric power supply device supplies no electric power for the protective device. In view of the above, the electric power supply device does not supply electric power to the motive power device and the protective device at the same time. The second end of the switch is controlled to connect to either the motive power device or the protective device. That is, the electric power supply device is configured to supply electric power to the motive power device or the protective device. The electric power supply device is configured to supply electric power to the motive power device or the protective device corresponding to the connection of the second end.

To ensure that the protective device can function to the greatest extent, the electric power supply device does not supply electric power to the protective device and the motive power device at the same time. That is, when the protective device is working, the motive power device is in a status of stopping working. The protective device can reduce an exerted force between the aerial vehicle and another object when the aerial vehicle (such as an aerial vehicle body) contacts the another object, so as to achieve the objective of preventing damage to the aerial vehicle and the another object.

In addition, due to such a cooperative mode among the electric power supply device, the protective device, and the motive power device, the protective device can be initiated automatically rather than manually, thereby realizing automatic protection of the aerial vehicle.

The protective device is configured to reduce an impact force between the aerial vehicle and another object. In a situation that the electric power supply device supplies electric power to the protective device, the switch of the protective device can be turned on to initiate the protective device. The protective device can include a parachute and/or a safety airbag. That is, a parachute and/or a safety airbag can be mounted on the aerial vehicle body.

The parachute is an aeronautical device that can reduce a falling speed of an object based on a principle of air resistance. The safety airbag is an airbag buffering device that can generate a large amount of gas instantaneously through igniting a gas generating agent.

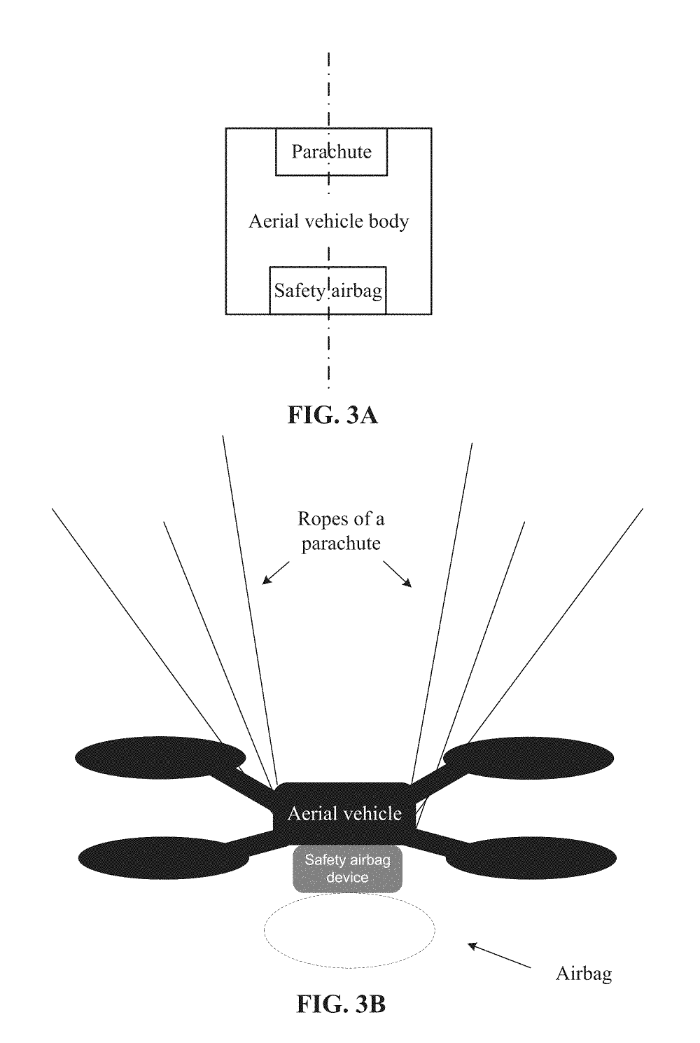

FIG. 3A shows a schematic diagram of positions of the parachute and the safety airbag on the aerial vehicle body. As shown in FIG. 3A, a parachute is mounted on the top of the aerial vehicle body, a safety airbag based on ultrasonic control is mounted on the bottom, and the parachute and the safety airbag can be disposed on a perpendicular bisector of the aerial vehicle body (for example, the broken line in FIG. 3A). When the aerial vehicle is in a normal flight status, the parachute and the safety airbag are in an unused status, for example, are received in the aerial vehicle body. The parachute and the safety airbag both have an opening device such as a switch. When the aerial vehicle is in an abnormal status, the opening device of the parachute will be powered to open the parachute. In addition, the protective device can further include an altitude sensor connected with the safety airbag, and the altitude sensor can further include, but is not limited to, an ultrasonic sensor. The electrified altitude sensor can detect an altitude between the aerial vehicle body and the ground, and open the safety airbag when the altitude is smaller than or equal to a preset altitude. FIG. 3B shows a schematic diagram of the effects of opening the parachute and the safety airbag.

The parachute is disposed on the top of the aerial vehicle body. After the parachute is opened, the parachute can provide an upward lift force to the aerial vehicle body, so as to reduce the falling speed of the aerial vehicle body, adjust the falling posture of the aerial vehicle body, ensure that the aerial vehicle body can fall to the ground with the bottom facing downward as much as possible, and allow the safety airbag to implement the buffering function to the maximum extent after being opened, thereby protecting the aerial vehicle body to the greatest extent. In view of this, the parachute at least has two functions, one is to reduce the falling speed of the aerial vehicle, and the other is to ensure to make the safety airbag function to the maximum extent.

The protective device can further include an altitude sensor connected to the safety airbag, and the altitude sensor can include, but is not limited to, an ultrasonic sensor. The altitude sensor is configured to detect an altitude of the aerial vehicle body from the ground. An altitude value for opening is preset. When the altitude sensor detects that the altitude of the aerial vehicle body from the ground is smaller than or equal to a safety altitude value, a switch, such as an ignition switch, of the safety airbag can be turned on, so as to make the body of the safety airbag eject out from the aerial vehicle body to provide a buffering force to the aerial vehicle body.

In some embodiments, the ultrasonic sensor can detect whether an object is on the ground. In such situation, the ultrasonic sensor takes the altitude from the object as an altitude to be compared with the safety altitude value, and opens the safety airbag when the altitude from the object is smaller than or equal to the safety altitude value. In view of the above, the ultrasonic sensor detects an altitude of the aerial vehicle body from a to-be-contacted object. The to-be-contacted object is the object that the aerial vehicle body will contact when landing, and may be the ground or an object on the ground.

According to the technical solution, a switch is disposed on the aerial vehicle body in FIG. 1, one end of the switch is connected to the electric power supply device, and the other end is connected to the motive power device and the protective device respectively. When the aerial vehicle body is flying normally, the switch is connected to the motive power device, so that the electric power supply device supplies electric power to the motive power device. When the aerial vehicle body is in an abnormal status, the switch can break a connection with the motive power device, so that the aerial vehicle falls freely, and furthermore, the switch establishes a connection with the protective device, so that the electric power supply device supplies electric power to the protective device. The protective device can provide a protection force to the aerial vehicle body when the aerial vehicle body falls and even collides with another object, so as to prevent the aerial vehicle body from being damaged or damaging other objects, thereby protecting the aerial vehicle body and other objects.

In the aerial vehicle shown in FIG. 1, the switch remote controller can send a control signal to the switch, but an abnormal status of the aerial vehicle needs to be found manually, and an instruction needs to be sent to the switch remote controller manually to trigger the switch remote controller to send a control signal to the switch in the aerial vehicle body. The manual operation is not sufficiently automated and cannot perform detection in time, resulting that the protective device cannot operate in time.

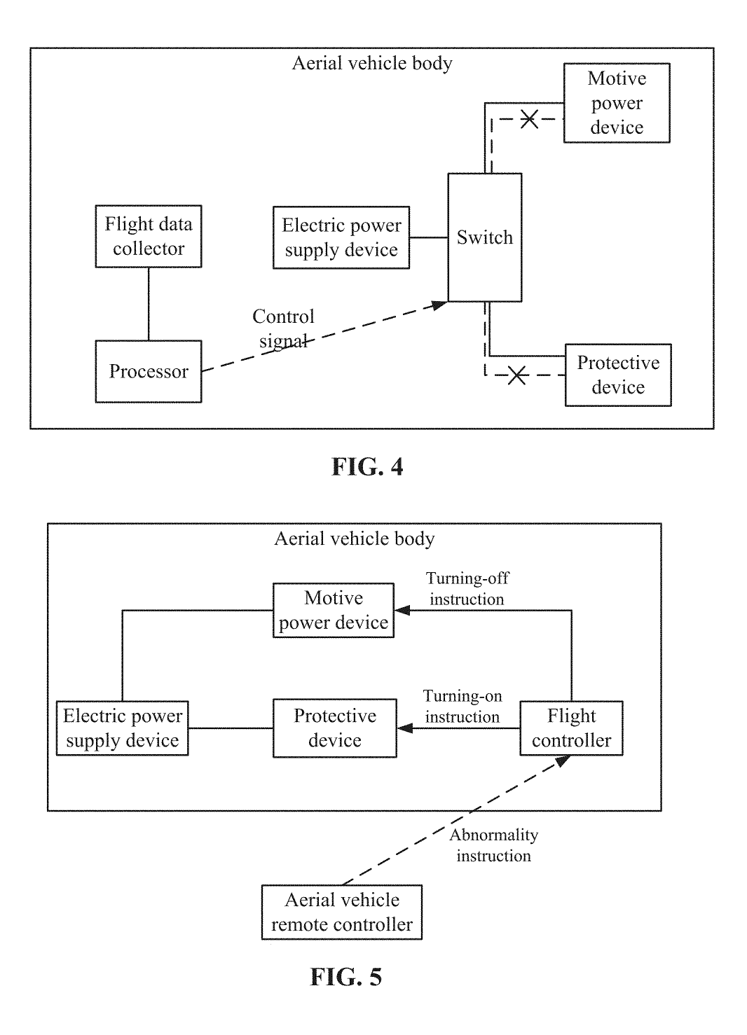

To automatically monitor an abnormal status of an aerial vehicle, the present disclosure provides another aerial vehicle. As shown in FIG. 4, the aerial vehicle includes a processor, a flight data collector, an electric power supply device, a motive power device, a protective device, and a switch disposed in the aerial vehicle body. To distinguish from the processor in the subsequent text, the processor may be referred to as the first processor.

In some embodiments, the aerial vehicle comprises: an electric power supply device, a motive power device, a switch, and a protective device. A first end of the switch is connected to the electric power supply device, and a second end of the switch is controlled to connect to either the motive power device or the protective device. The electric power supply device is configured to supply electric power to the motive power device or the protective device corresponding to the connection of the second end. After the second end is connected to the protective device, the protective device is configured to reduce an exerted force between the aerial vehicle and another object when the aerial vehicle collides with the another object. The protective device comprises a parachute and a safety airbag.

The flight data collector is configured to detect flight data of the aerial vehicle, and can include, but is not limited to, one or more of a positioning module, a gyroscope, and a barometer. For example, the positioning module is a Global Positioning System (GPS), and can acquire position data of the aerial vehicle, the gyroscope can acquire flight posture data of the aerial vehicle, and the barometer can acquire flight altitude data of the aerial vehicle.

The processor is connected to the flight data collector, so as to acquire flight data of the aerial vehicle collected by the flight data collector. A flight abnormality condition is preset in the processor, if the processor determines that the flight data of the aerial vehicle satisfies the preset flight abnormality condition, the processor sends a control signal to the switch, so that the switch breaks a connection between the electric power supply device and the motive power device, and establishes a connection between the electric power supply device and the protective device.

The processor determines whether the flight data of the aerial vehicle satisfies the flight abnormality condition in the following situations, but is not limited to these situations.

For example, the flight data of the aerial vehicle includes a positioning signal intensity and a quantity of detected positioning satellites, and the flight abnormality condition can be based on a positioning signal intensity threshold and a quantity threshold of positioning satellites. If the positioning signal intensity of the aerial vehicle is lower than the positioning signal intensity threshold and the quantity of detected positioning satellites is lower than the quantity threshold of positioning satellites, the aerial vehicle can be determined to be in an abnormal flight status.

Furthermore, the flight data of the aerial vehicle includes a flight posture value detected by the gyroscope, and the flight abnormality condition can be a flight posture standard value. If the difference between the flight posture value of the aerial vehicle and the flight posture standard value is larger than a preset difference threshold, the aerial vehicle can be determined to be in an abnormal flight status.

Furthermore, the flight data of the aerial vehicle includes a flight altitude detected by the barometer in a time period, and the flight abnormality condition can be a flight altitude change threshold. If the change value of the flight altitude of the aerial vehicle in a time period is larger than the flight altitude change threshold, the aerial vehicle can be determined to be in an abnormal flight status.

Furthermore, the flight data of the aerial vehicle includes an electric motor torque in a time period, and the flight abnormality condition can be an electric motor torque change threshold. If the electric motor torque change value of the aerial vehicle in a time period is larger than the electric motor torque change threshold, the aerial vehicle can be determined to be in an abnormal flight status.

To enhance accuracy, the processor can determine whether the aerial vehicle is in an abnormal flight status according to various types of flight data.

If the processor determines the flight data of the aerial vehicle satisfies the preset flight abnormality condition, the processor sends a control signal to the switch, so that the switch breaks a connection between the electric power supply device and the motive power device, and establishes a connection between the electric power supply device and the protective device. In some embodiments, the motive power device and the protective device may be referred to from the foregoing embodiments and will not be described repeatedly. The processor can be disposed on the aerial vehicle body or a monitoring device on the ground.

According to the foregoing technical solution, a processor and a flight data collector can be disposed on the aerial vehicle, the flight data collector can acquire status data of the aerial vehicle during flight, and send the flight status data to the processor, the processor determines whether the aerial vehicle is in an abnormal flight status according to the flight status data, and if the aerial vehicle is in an abnormal flight status, sends a control signal to the switch, so that the switch breaks supply of the electric power supply device to the motive power device, and makes the electric power supply device supply electric power to the protective device, and thus, the protective device can provide a safety protection function for the aerial vehicle when the aerial vehicle is in an abnormal flight status. Thus, the processor and the flight data collector in the aerial vehicle can replace the switch remote controller to realize self-monitoring of an abnormal situation and initiate a safety protection function more automatically and timely.

In some embodiments, there may be one or more electric power supply devices. The motive power device and the protective device can share one electric power supply device or use separate electric power supply devices. In a situation that the motive power device and the protective device are supplied with electric power by the electric power supply devices separately, a switch does not need to be disposed in the aerial vehicle body, as long as a connection is established between the protective device and the electric power supply device after a connection between the motive power device and the electric power supply device is broken. The connection between the protective device and the electric power supply device can be established at the same time as or after breaking the connection between the motive power device and the electric power supply device. In some embodiments, breaking a connection between the motive power device and the electric power supply device represents that the motive power device stops working, and establishing a connection between the protective device and the electric power supply device represents that the protective device starts working.

In some embodiments, the processor in the foregoing embodiment can be an independent processor or a flight controller of an aerial vehicle. That is, the flight controller not only has an existing function of controlling a flight posture of an aerial vehicle, but also implements examination of an abnormal status of the aerial vehicle and a safety protection function in an abnormal status. However, when the aerial vehicle is in an abnormal status, the flight controller is also likely to fail. Therefore, the processor independent of the flight controller can be configured to implement the safety protection function in a better way.

In some embodiments, the switch in the present disclosure can be in various forms, for example, there are two switches, that is, a first switch connected to the motive power device and a second switch connected to the protective device. In a situation that two switches are included, two control signals can be sent to the switches, that is, the first switch control signal and the second switch control signal. The first switch control signal is configured to control the first switch to break a connection between the electric power supply device and the motive power device, and the second switch control signal is configured to control the second switch to establish a connection between the electric power supply device and the protective device.

FIG. 5 shows another structure of the aerial vehicle provided by the present disclosure. As shown in FIG. 5, the aerial vehicle includes an aerial vehicle remote controller and an aerial vehicle body. A flight controller, a motive power device, an electric power supply device, and a protective device are disposed in the aerial vehicle body. In some embodiments, the flight controller and the first processor can be the same processor or different processors. To describe conveniently, the flight controller can be referred to as a second processor.

If an abnormal flight status in the aerial vehicle body is found manually, the aerial vehicle remote controller can send an abnormality instruction to the flight controller in the aerial vehicle body, and the abnormality instruction is configured to notify the flight controller that the aerial vehicle body is in an abnormal status. After receiving the abnormality instruction, the flight controller can generate two instructions, that is, a turning-on instruction and a turning-off instruction. Alternatively, the flight controller can determine whether the aerial vehicle is in an abnormal flight status according to flight data, and generate a turning-off instruction and a turning-on instruction if the aerial vehicle is in an abnormal flight status.

The turning-off instruction is configured to instruct the motive power device to stop providing a driving force to the aerial vehicle. For example, the turning-off instruction is sent to the motive power device to set an output voltage of the electronic speed regulator in the motive power device as a preset minimum value, to change the rotation speed of the electric motor to the minimum value, so that the motive power parts such as a propeller stop working. For example, an electronic speed regulator is set in the flight controller and controls an output voltage provided by the electric power supply device for the electric motor, so as to control the rotation speed of the electric motor. The flight controller sends the turning-off instruction to the electronic speed regulator, and the instruction can adjust a duty cycle of the electronic speed regulator to achieve the objective of controlling the motive power parts of the aerial vehicle.

The turning-on instruction is configured to initiate the protective device. If the protective device needs an electric power supply device to supply electric power, the initiation refers to establishing a connection between the protective device and the electric power supply device. Alternatively, no matter whether the protective device needs an electric power supply device to supply electric power, the initiation refers to opening a protective part such as a parachute in the protective device. The working process of the protective device being supplied with electric power may be referred to from the description of the foregoing embodiment and will not be described repeatedly.

In some embodiments, the turning-off instruction and the turning-on instruction can be referred to as a first instruction and a second instruction respectively. The turning-off instruction sent to the motive power device and the turning-on instruction sent to the protective device can be generated at the same time, or the turning-off instruction is generated first and then the turning-on instruction is generated.

Regarding the foregoing aerial vehicle, the flight controller is configured to perform safety protection on the aerial vehicle and an independent processor does not need to be disposed in the aerial vehicle, so as to simplify the structure of the aerial vehicle. In addition, the effect realized by the flight controller sending a turn-off instruction to the motive power device is the same as the effect of breaking a connection between the electric power supply device and the motive power device. Therefore, additional hardware does not need to be added to the aerial vehicle, so as to further simplify the structure of the aerial vehicle.

In some embodiments, one or more of the foregoing aerial vehicles can be integrated into the same aerial vehicle, so as to ensure that when one safety protection mechanism fails, another safety protection mechanism can be used as backup, and enhance the potential application of the safety protection function.

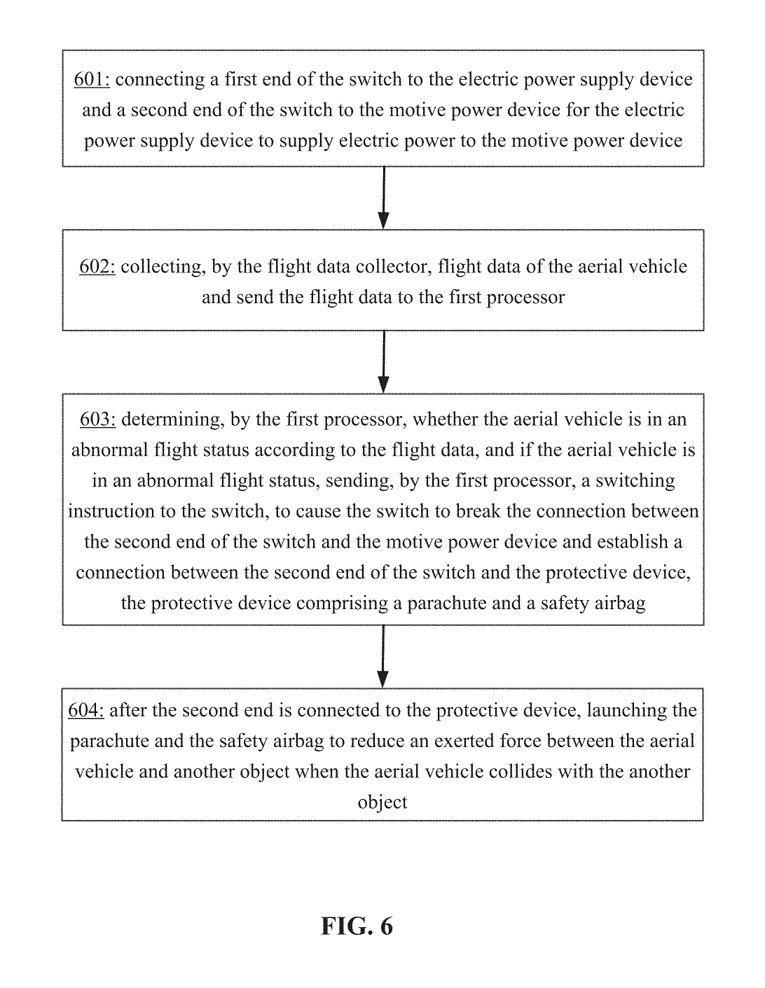

FIG. 6 shows a flow chart for an aerial vehicle operation method 600 according to some embodiments of the present disclosure. The exemplary method 600 may be implemented by an aerial vehicle described above including an electric power supply device, a motive power device, a switch, a protective device, a first processor, and a flight data collector. The operations of the method 600 presented below are intended to be illustrative. Depending on the implementation, the exemplary method 600 may include additional, fewer, or alternative steps performed in various orders or in parallel.

Block 601 includes connecting a first end of the switch to the electric power supply device and a second end of the switch to the motive power device for the electric power supply device to supply electric power to the motive power device. Block 602 includes collecting, by the flight data collector, flight data of the aerial vehicle and send the flight data to the first processor. Block 603 includes determining, by the first processor, whether the aerial vehicle is in an abnormal flight status according to the flight data, and if the aerial vehicle is in an abnormal flight status, sending, by the first processor, a switching instruction to the switch, to cause the switch to break the connection between the second end of the switch and the motive power device and establish a connection between the second end of the switch and the protective device, the protective device comprising a parachute and a safety airbag. Block 604 includes after the second end is connected to the protective device, launching the parachute and the safety airbag to reduce an exerted force between the aerial vehicle and another object when the aerial vehicle collides with the another object. As being powered now from the second end, the protective device can operate to protect the aerial vehicle.

In some embodiments, the parachute is disposed on a top surface of a body of the aerial vehicle, and the safety airbag is disposed on a bottom surface of a body of the aerial vehicle.

In some embodiments, the protective device further comprises an altitude sensor; and launching the parachute and the safety airbag to reduce an exerted force between the aerial vehicle and another object when the aerial vehicle collides with the another object comprises launching the parachute and the safety airbag when the altitude sensor detects that an altitude of the aerial vehicle body satisfies a preset condition (e.g., below a preset altitude).

Each embodiment of the specification is described in a progressive manner, each embodiment highlights an aspect that is different from other embodiments, and the embodiments may be referred to between one another for the same or similar parts.

The relational terms herein such as first and second are used only to differentiate an entity or operation from another entity or operation, and do not require or imply any actual relationship or sequence between these entities or operations. Moreover, the terms “include”, “comprise”, and any variants thereof are intended to cover a non-exclusive inclusion. Therefore, in the context of a process, method, object, or device that includes a series of elements, the process, method, object, or device not only includes such elements, but also includes other elements not specified expressly, or may include inherent elements of the process, method, object, or device. Unless otherwise specified, an element limited by “include a/an . . . ” does not exclude other same elements existing in the process, the method, the article, or the device that includes the element.

According to the foregoing description of the disclosed embodiments, a person skilled in the art can implement or use the present disclosure. The general principle defined in the present disclosure can be implemented in other embodiments without departing from the spirit or scope of the present disclosure. Therefore, the present disclosure will not be limited to these embodiments in the present disclosure, but falls in a broadest scope that is consistent with the principle and novel features disclosed in the present disclosure.

What is claimed is:

1. An aerial vehicle, comprising: an electric power supply device, a motive power device, and a protective device disposed in an aerial vehicle body, wherein:
the electric power supply device is configured to supply electric power to the motive power device or the protective device; and
the protective device is configured to reduce an exerted force between the aerial vehicle and another object when the aerial vehicle collides with the another object.

2. The aerial vehicle according to claim 1, wherein:
the protective device comprises a parachute disposed on a top surface of the aerial vehicle body.

3. The aerial vehicle according to claim 1, wherein:
the protective device comprises a safety airbag disposed on a bottom surface of the aerial vehicle body.

4. The aerial vehicle according to claim 3, wherein:
the protective device further comprises an altitude sensor; and
the altitude sensor is connected to the safety airbag and is configured to open the safety airbag when detecting an altitude of the aerial vehicle body satisfies a preset condition.

5. The aerial vehicle according to claim 1, further comprising a switch, wherein:
one end of the switch is connected to the electric power supply device, and the other end is connected to the motive power device or the protective device.

6. The aerial vehicle according to claim 5, wherein:
the switch is configured to obtain from a remote controller a switching instruction to cause the switch to break a connection between the other end of the switch and the motive power device and establish a connection between the other end of the switch and the protective device.

7. The aerial vehicle according to claim 5, further comprising a first processor and a flight data collector, wherein:
the flight data collector is configured to collect flight data of the aerial vehicle and send the flight data to the first processor; and
the first processor is configured to determine whether the aerial vehicle is in an abnormal flight status according to the flight data, and if the aerial vehicle is in an abnormal flight status, send a switching instruction to the switch, to cause the switch to break a connection between the other end of the switch and the motive power device and establish a connection between the other end of the switch and the protective device.

8. The aerial vehicle according to claim 1, further comprising a second processor, wherein:
the second processor is configured to send a first instruction to the motive power device, to cause the motive power device to stop providing a driving force to the aerial vehicle, and send a second instruction to the protective device to cause the protective device to initiate.

9. The aerial vehicle according to claim 8, wherein:
the motive power device further comprises an electronic speed regulator; and
the electronic speed regulator is connected to the second processor and is configured to set a voltage output to an electric motor of the motive power device to a preset minimum value after receiving the first instruction.

10. The aerial vehicle according to claim 1, further comprising a first switch and a second switch, wherein:
the first switch is connected to the electric power supply device and the motive power device respectively on two ends of the first switch, and the second switch is connected to the electric power supply device and the protective device respectively on two ends of the second switch.

11. An aerial vehicle, comprising: an electric power supply device, a motive power device, a switch, and a protective device, wherein:
a first end of the switch is connected to the electric power supply device, and a second end of the switch is controlled to connect to either the motive power device or the protective device;
the electric power supply device is configured to supply electric power to the motive power device or the protective device corresponding to the connection of the second end;
after the second end is connected to the protective device, the protective device is configured to reduce an exerted force between the aerial vehicle and another object when the aerial vehicle collides with the another object; and
the protective device comprises a parachute and a safety airbag.

12. The aerial vehicle according to claim 11, wherein:
the parachute is disposed on a top surface of a body of the aerial vehicle; and
the safety airbag is disposed on a bottom surface of a body of the aerial vehicle.

13. The aerial vehicle according to claim 11, wherein:
the protective device further comprises an altitude sensor; and
the altitude sensor is connected to the safety airbag and is configured to open the safety airbag when detecting an altitude of the aerial vehicle satisfies a preset condition.

14. The aerial vehicle according to claim 11, wherein:
the switch is configured to obtain from a remote controller a switching instruction to cause the switch to break a connection between the second end of the switch and the motive power device and establish a connection between the second end of the switch and the protective device.

15. The aerial vehicle according to claim 11, further comprising a first processor and a flight data collector, wherein:
the flight data collector is configured to collect flight data of the aerial vehicle and send the flight data to the first processor; and
the first processor is configured to determine whether the aerial vehicle is in an abnormal flight status according to the flight data, and if the aerial vehicle is in an abnormal flight status, send a switching instruction to the switch, to cause the switch to break a connection between the second end of the switch and the motive power device and establish a connection between the second end of the switch and the protective device.

16. The aerial vehicle according to claim 11, further comprising a second processor, wherein:
the second processor is configured to send a first instruction to the motive power device, to cause the motive power device to stop providing a driving force to the aerial vehicle, and send a second instruction to the protective device to cause the protective device to initiate.

17. A method, implementable by an aerial vehicle including an electric power supply device, a motive power device, a switch, a protective device, a first processor, and a flight data collector, the method comprising:
connecting a first end of the switch to the electric power supply device and a second end of the switch to the motive power device for the electric power supply device to supply electric power to the motive power device;
collecting, by the flight data collector, flight data of the aerial vehicle and send the flight data to the first processor;
determining, by the first processor, whether the aerial vehicle is in an abnormal flight status according to the flight data, and if the aerial vehicle is in an abnormal flight status, sending, by the first processor, a switching instruction to the switch, to cause the switch to break the connection between the second end of the switch and the motive power device and establish a connection between the second end of the switch and the protective device, the protective device comprising a parachute and a safety airbag; and
after the second end is connected to the protective device, launching the parachute and the safety airbag to reduce an exerted force between the aerial vehicle and another object when the aerial vehicle collides with the another object.

18. The method according to claim 17, wherein:
the parachute is disposed on a top surface of a body of the aerial vehicle.

19. The method according to claim 17, wherein:
the safety airbag is disposed on a bottom surface of a body of the aerial vehicle.

20. The method according to claim 17, wherein:
the protective device further comprises an altitude sensor; and
the abnormal flight status includes that an altitude of the aerial vehicle body satisfies a preset condition.
